(19) United States
(12) Patent Application Publication
(10) Pub. No.: US 2026/0168521 A1
(43) Pub. Date: Jun. 18, 2026

(54) ACTUATORS WITH SEALED PISTONS

(71) Applicant: Roller Bearing Company of America, Inc., Oxford, CT (US)

(72) Inventors: Peter Colliard, Oxford, CT (US); Bradley T Smith, Oxford, CT (US); Charles Condon, Oxford, CT (US)

(73) Assignee: Roller Bearing Company of America, Inc., Oxford, CT (US)

(21) Appl. No.: 19/410,436

(22) Filed: Dec. 5, 2025

Related U.S. Application Data
(60) Provisional application No. 63/734,302, filed on Dec. 16, 2024.

(51) Int. Cl. F15B 15/14; F16C 33/10

(52) U.S. Cl. CPC F15B 15/1447; F16C 33/1025

(57) ABSTRACT

A linear actuator is provided that includes a housing, a piston, and an anti-rotation assembly. The piston is movable along a linear axis within the housing. The anti-rotation assembly prevents the piston from rotating within the housing about the linear axis. The anti-rotation assembly includes a transverse keyway in the piston and a slip-key secured to the housing in the transverse keyway.

### CROSS REFERENCE TO RELATED APPLICATIONS

This application claims benefit under of US Application 63/734,302 filed Dec. 16, 2024, the entire contents of which are incorporated herein by reference.

### BACKGROUND

### 1. Field of the Invention

The present disclosure is related to linear actuators. More particularly, the present disclosure is related to linear actuators with sealed pistons that include self-lubricating bushings and/or anti-rotation assemblies.

### 2. Description of Related Art

Linear actuators that move a piston are commonly used in industrial applications. Typically, the linear actuator has a piston that is movable within a housing between an extended position and a retracted position.

The design, assembly, operation, and maintenance of linear actuators requires the balancing of a number of important aspects such as, but not limited to, lubrication, sealing, piston weight, and preventing rotation of the piston within the housing.

In the prior art, these design constraints compete against one another. For example, the prior art linear actuators that provide better lubrication or sealing are more difficult and costly to assemble and/or maintain. Conversely, the prior art linear actuators that are easier to assemble and/or maintain suffer from leakage and lubrication failures.

Accordingly, it has been determined by the present disclosure that there is a need for linear actuators that overcome, alleviate, and/or mitigate one or more of the aforementioned and other deleterious effects of the prior art.

### SUMMARY

A linear actuator is provided that includes a housing, a piston, and an anti-rotation assembly. The piston is movable along a linear axis within the housing. The anti-rotation assembly prevents the piston from rotating within the housing about the linear axis. The anti-rotation assembly includes a transverse keyway in the piston and a slip-key secured to the housing in the transverse keyway.

In some embodiments either alone or together with any one or more of the aforementioned and/or after-mentioned embodiments, the slip-key is removably secured to the housing.

In some embodiments either alone or together with any one or more of the aforementioned and/or after-mentioned embodiments, the anti-rotation assembly limits rotation of the piston within the housing to less than 1 degree.

In some embodiments either alone or together with any one or more of the aforementioned and/or after-mentioned embodiments, the piston has a circular cross-section and the transverse keyway is a flat in the circular cross-section.

In some embodiments either alone or together with any one or more of the aforementioned and/or after-mentioned embodiments, the slip-key remains stationary with respect to the housing and slides within the transverse keyway during movement of the piston along the linear axis.

In some embodiments either alone or together with any one or more of the aforementioned and/or after-mentioned embodiments, the anti-rotation assembly further includes self-lubricating coating or liner on the slip-key and/or the transverse keyway.

In some embodiments either alone or together with any one or more of the aforementioned and/or after-mentioned embodiments, the slip-key is made entirely of self-lubricating material.

In some embodiments either alone or together with any one or more of the aforementioned and/or after-mentioned embodiments, the slip-key is removable without withdrawing the piston from the housing.

A linear actuator is also provided that includes a housing, self-lubricating bushings, a piston, and an anti-rotation assembly. The self-lubricating bushings are secured in each end of the housing. The piston is movably supported by the self-lubricating bushings so that the piston is movable along a linear axis between an extended position and a retracted position with respect to the housing. The anti-rotation assembly prevents the piston from rotating within the housing about the linear axis. The anti-rotation assembly does not contact the self-lubricating bushings at any position between the extended and retracted positions.

In some embodiments either alone or together with any one or more of the aforementioned and/or after-mentioned embodiments, the linear actuator further includes a seal at each end of the housing. The anti-rotation assembly does not contact the seals at any position between the extended and retracted positions.

In some embodiments either alone or together with any one or more of the aforementioned and/or after-mentioned embodiments, the self-lubricating bushings are removable from the housing.

In some embodiments either alone or together with any one or more of the aforementioned and/or after-mentioned embodiments, the self-lubricating bushings are removable from the housing without removing the anti-rotation assembly.

In some embodiments either alone or together with any one or more of the aforementioned and/or after-mentioned embodiments, the anti-rotation assembly includes a transverse keyway in the piston and a slip-key secured to the housing in the transverse keyway.

In some embodiments either alone or together with any one or more of the aforementioned and/or after-mentioned embodiments, the slip-key is removably secured to the housing.

In some embodiments either alone or together with any one or more of the aforementioned and/or after-mentioned embodiments, the piston has a circular cross-section and the transverse keyway is a flat in the circular cross-section.

In some embodiments either alone or together with any one or more of the aforementioned and/or after-mentioned embodiments, the slip-key remains stationary with respect to the housing and slides within the transverse keyway during movement of the piston along the linear axis.

In some embodiments either alone or together with any one or more of the aforementioned and/or after-mentioned embodiments, the anti-rotation assembly further includes self-lubricating coating or liner on the slip-key and/or the transverse keyway.

In some embodiments either alone or together with any one or more of the aforementioned and/or after-mentioned embodiments, the slip-key is removable without withdrawing the piston from the housing.

The above-described and other features and advantages of the present disclosure will be appreciated and understood by those skilled in the art from the following detailed description, drawings, and appended claims.

### DESCRIPTION OF THE DRAWINGS

FIG. 1 is a first perspective view of an exemplary embodiment of a linear actuator according to the present disclosure;

FIG. 2 is a second, opposite perspective view of the linear actuator of FIG. 1;

FIG. 3 is a sectional view of the linear actuator of FIG. 1 taken along line 3-3 showing the piston in an extended position;

FIG. 4 is a view of the linear actuator of FIG. 3 showing the piston is a retracted position;

FIG. 5 a top perspective view of a slip-key according to the present disclosure; and

FIG. 6 is a bottom perspective view of the slip-key of FIG. 5.

### DETAILED DESCRIPTION

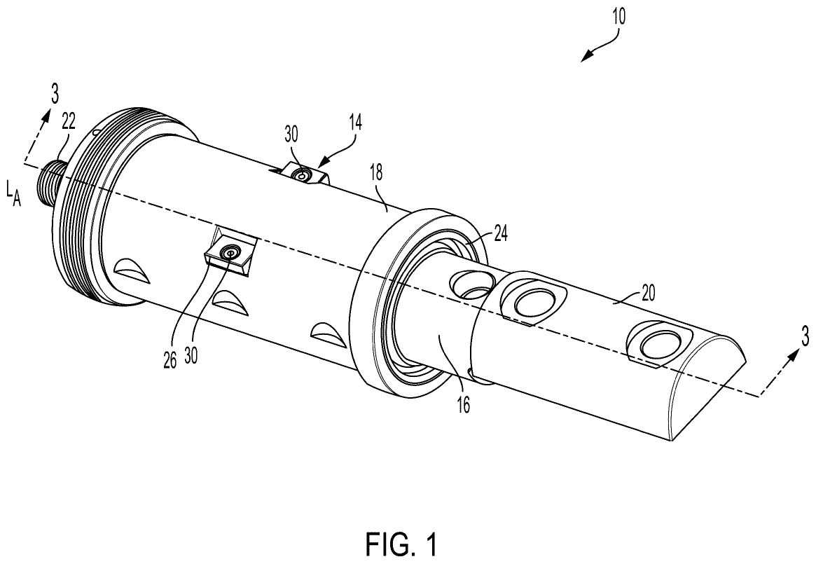

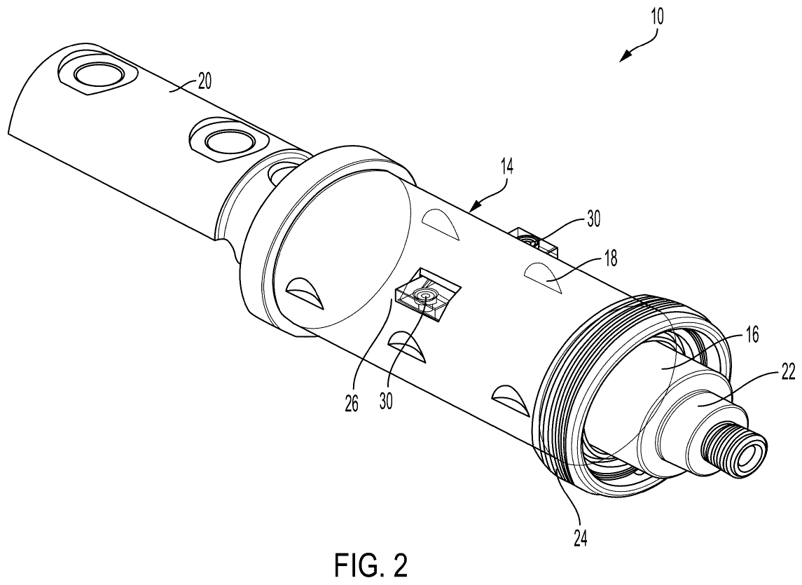

An exemplary embodiment of a linear actuator according to the present disclosure is shown and is referred to by reference number 10 with simultaneous reference to FIGS. 1-4.

Advantageously, linear actuator 10 includes one or more self-lubricating bushings 12 and an anti-rotation assembly 14, which alone and/or in combination ensure and enhance the sealing of the actuator during assembly and operation, while affording ease of maintenance of the actuator.

Actuator 10 includes a piston 16 and a housing 18, where the piston is supported in the housing by bushings 12. In the illustrated embodiment, actuator 10 includes two bushings 12, one at each end of housing 18.

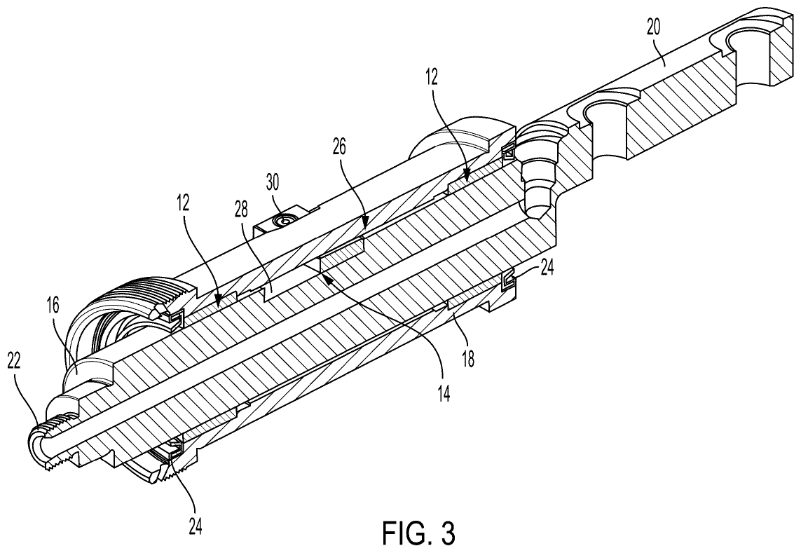

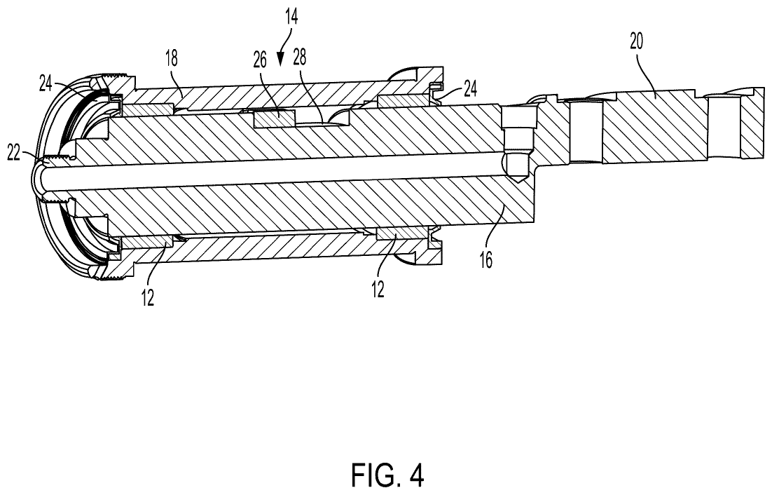

Piston 16 can be moved between an extended position (FIG. 3) and a retracted position (FIG. 4) along a linear axis L_{A}.

Anti-rotation 14 assembly restricts rotation between piston 16 and housing 18 and is advantageously configured to avoid contact with actuator seals and self-lubricating bushings during assembly, use, and maintenance of the actuator.

For example, piston 16 can have a driving end 20 and a driven end 22. Driving end 20 can be secured to a motion inducer (not shown) such as, but not limited to, a pneumatic drive, hydraulic drive, a mechanical drive, a rotational drive, and others. In this manner, a force is applied to piston 16 at driving end 20 to move the piston along axis L_{A}. Driven end 22 can be configured for any desired use such as, but not limited to, a metal shaping ram, container capping rams, and others.

Actuator 10 can include a seal 24 at each end of housing 18 to seal off the housing from dirt and debris. In the illustrated embodiment, seal 24 is shown as a polymer wiper seal.

Anti-rotation assembly 14 restricts rotation between piston 16 and housing 18. Advantageously, anti-rotation assembly 14 is configured to avoid contact with seals 24 during assembly, use, and maintenance of actuator 10 as described in more detail below.

Anti-rotation assembly 14 includes a slip-key 26 and a transverse keyway 28, which is positioned in piston 16. Slip-key 26 is removably secured to housing 18. For example, slip-key 26 can be removably secured to housing 18 by one or mechanical fasteners 30 (two shown). Once secured to housing 18, slip-key 26 remains stationary with respect to housing 18 and slides within keyway 28 during movement of piston 16 along linear axis L_{A}, while preventing rotation of the piston within the housing about the linear axis.

In some embodiments, anti-rotation assembly 14 is configured to limit the rotational degrees of freedom of piston 16 within housing 18 to less than 2 degrees, more preferably less than 1 degree.

Slip-key 26 and/or transverse keyway 28 can include a self-lubricating coating or liner.

In some embodiments, bushings 12 and/or slip-key 26 can have a self-lubricating coating such as, but not limited to, that disclosed in Applicant's own U.S. Pat. No. 8,034,865, which is incorporated herein by reference.

In other embodiments, bushings 12 and/or slip-key 26 can have a self-lubricating liner made from a friction-reducing (“self-lubricating”) material such as polytetrafluoroethylene (PTFE), graphite, nylon, acetal plastics, Polyoxymethylene (POM), also known as Delrin, Polyether ether ketone (PEEK), and others.

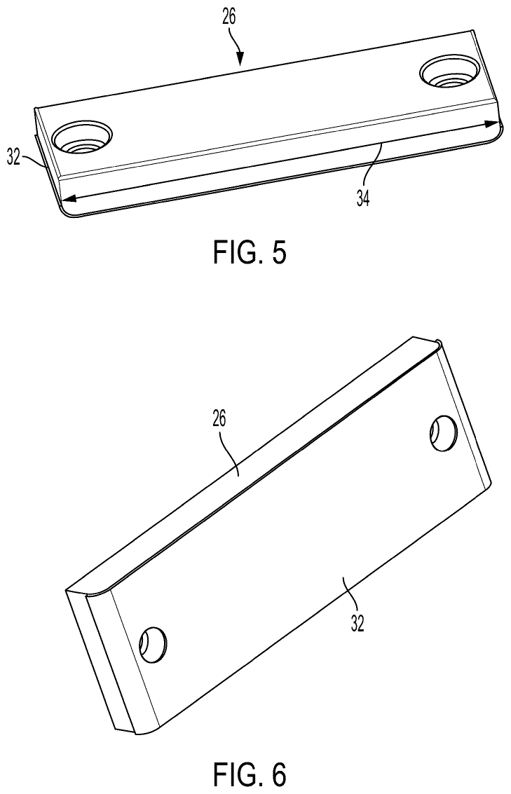

In the embodiment of slip-key 26 shown in FIGS. 5-6, slip-key 26 has a self-lubricating liner 32 secured to a surface that contacts keyway 28 within piston 16.

Of course, it is contemplated by the present disclosure for slip-key 26 to be made entirely of self-lubricating material.

In some embodiments, slip-key 26 is made of machinable self-lubricating material, which allows the slip-key to be provided with a thickness that can be machined to the tolerances between piston 16 and housing 18 of a specific actuator 10.

Contrary to prior part keyways that run along the piston and have keys that move along with the shaft, slip-key 26 is stationary and has a major axis 34 that is perpendicular to the travel direction of piston 16 along linear axis L_{A}. In this manner, slip-key 26 can be removed from actuator 10 without withdrawing piston 16 from housing 18. Simply, anti-rotation assembly 14 is configured to allow easy replacement of the parts subject to wear, namely slip-key 26.

It has been found by the present disclosure that eliminating unnecessary removal of piston 16 from housing 18 when replacing the wearable parts of anti-rotation assembly 14 reduces wear-and-tear or damage to bushings 12 and/or seals 24.

Additionally, anti-rotation assembly 14 is advantageously configured to avoid contact with bushings 12 and seals 24 during assembly, use, and maintenance of actuator 10. In particular, piston 16 is inserted into bushings 12 and seals 24 without slip-key 26 installed - meaning that the slip-key cannot contact the bushings or seals. Once piston 16 is in housing 18, slip-key 26 can then be passed through an opening in the housing into keyway 28 and secured in place.

In some embodiments, keyway 28 is a flat machined into piston 16 such that the piston can have a circular cross-section. It has been found by the present disclosure that this structure, namely keyway 28 being a flat machined into a circular shaft that forms piston 16 allows for the use of off the shelf shafts, seals 24, and easily machined bushings 12.

Moreover, this structure has been found by the present disclosure to provide actuator 10 configured so that the portion of piston 16 in contact with bushings 12 and seals 24 are circular, which is believed to provide enhanced sealing and reduced wear as compared to other cross-sections.

As can be seen from the movement of piston 16 to extended position (FIG. 3) and retracted position (FIG. 4), actuator 10 is further configured so that anti-rotation assembly 14 advantageously avoid contacts with bushings 12 and seals 24 during use, which is further believed to enhance the longevity of the bushings and seals.

In some embodiments, actuator 10 is configured so that bushings 12 are removably secured in housing 18. The removable securement of bushings 12 to housing 18 can be provided by an interference or slip fit between the outer dimension of the bushings and the inner dimension of the housing. Alternatively, bushings 12 can be removably secured to housing 18 by one or more connectors (not shown) such as, but not limited to, a snap-ring or mechanical fastener.

As discussed above, bushing 12 can, in some embodiments, can include a self-lubricating coating or liner disposed on a metallic portion (not shown).

In the embodiment shown, bushings 12 are made of machinable self-lubricating material, which allows the bushings to be provided with an inner diameter that is smaller than an outer diameter of piston 16. This allows for bushings 12 to be replaced then to have their inner dimeter machined to the tolerance of piston 16 in the region of the bushing.

Advantageously, actuator 10 is configured to maintain the sealing of piston 16 in a number of ways. During installation and use, anti-rotation assembly 14 does not contact bushings 12 and/or seals 24. Furthermore, actuator 10 is configured so that during replacement of wearable components of anti-rotation assembly 14 it is not necessary to remove piston 16 from housing 18. Further, actuator 10 is configured so that the portion of piston 16 in bushings 12 and seals 24 are circular and the inner diameter can be machined to match the tolerances of the piston.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made, and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure is not limited to the particular embodiment(s) disclosed as the best mode contemplated, but that the disclosure will include all embodiments falling within the scope of the appended claims.

### PARTS LIST

linear actuator 10
self-lubricating bushing 12
anti-rotation assembly 14
piston 16
housing 18
linear axis LA
driving end 20
driven end 22
seal 24
slip-key 26
transverse keyway 28
mechanical fastener 30
self-lubricating liner 32
major axis 34

What is claimed is:

1. A linear actuator comprising:
a housing;
a piston movable along a linear axis within the housing; and
an anti-rotation assembly configured to prevent the piston from rotating within the housing about the linear axis, the anti-rotation assembly comprising a transverse keyway in the piston and a slip-key secured to the housing in the transverse keyway.

2. The linear actuator of claim 1, wherein the slip-key is removably secured to the housing.

3. The linear actuator of claim 1, wherein the anti-rotation assembly limits rotation of the piston within the housing to less than 1 degree.

4. The linear actuator of claim 1, wherein the piston has a circular cross-section, and wherein the transverse keyway is a flat in the circular cross-section.

5. The linear actuator of claim 1, wherein the slip-key remains stationary with respect to the housing and slides within the transverse keyway during movement of the piston along the linear axis.

6. The linear actuator of claim 1, wherein the anti-rotation assembly further comprises self-lubricating coating or liner on the slip-key and/or the transverse keyway.

7. The linear actuator of claim 1, wherein the slip-key is made entirely of self-lubricating material.

8. The linear actuator of claim 1, wherein the slip-key is removable without withdrawing the piston from the housing.

9. A linear actuator comprising:
a housing;
a self-lubricating bushing secured in each end of the housing;
a piston movably supported by the self-lubricating bushings so that the piston is movable along a linear axis between an extended position and a retracted position with respect to the housing;
an anti-rotation assembly configured to prevent the piston from rotating within the housing about the linear axis, wherein the anti-rotation assembly does not contact the self-lubricating bushings at any position between the extended and retracted positions.

10. The linear actuator of claim 9, further comprising a seal at each end of the housing, wherein the anti-rotation assembly does not contact the seals at any position between the extended and retracted positions.

11. The linear actuator of claim 9, wherein the self-lubricating bushings are removable from the housing.

12. The linear actuator of claim 9, wherein the self-lubricating bushings are removable from the housing without removing the anti-rotation assembly.

13. The linear actuator of claim 9, wherein the anti-rotation assembly comprises a transverse keyway in the piston and a slip-key secured to the housing in the transverse keyway.

14. The linear actuator of claim 13, wherein the slip-key is removably secured to the housing.

15. The linear actuator of claim 13, wherein the piston has a circular cross-section, and wherein the transverse keyway is a flat in the circular cross-section.

16. The linear actuator of claim 13, wherein the slip-key remains stationary with respect to the housing and slides within the transverse keyway during movement of the piston along the linear axis.

17. The linear actuator of claim 13, wherein the anti-rotation assembly further comprises self-lubricating coating or liner on the slip-key and/or the transverse keyway.

18. The linear actuator of claim 13, wherein the slip-key is removable without withdrawing the piston from the housing.
